(19) United States
(12) Patent Application Publication
(10) Pub. No.: US 2023/0399259 A1
(43) Pub. Date: Dec. 14, 2023

(54) CONSTRUCTION METHODS USING SYNTHETIC POLYMER BINDERS

(71) Applicant: Pike Scientific Industries LLC, Ooltewah, TN (US)

(72) Inventor: Andrew Pike, Ooltewah, TN (US)

(73) Assignee: Pike Scientific Industries LLC, Ooltewah, TN (US)

(21) Appl. No.: 18/330,500

(22) Filed: Jun. 7, 2023

Related U.S. Application Data
(60) Provisional application No. 63/350,529, filed on Jun. 9, 2022.

(51) Int. Cl. C04B 14/06; C04B 26/16; C04B 14/38; B28B 1/00

(52) U.S. Cl. CPC C04B 14/06; C04B 26/16; C04B 14/38; B28B 1/001

(57) ABSTRACT

A structural building system and method for forming and using a structural element at a building site using a structural mix comprised of an aggregate material sourced exclusively from the building site, a no-bake binder, and a strengthening additive. According to the method disclosed herein, aggregate material is sourced exclusively from a supply of aggregate material located at a building site. A no-bake binder is combined with the aggregate material in a mixer to form a structural mix at the building site. Finally, the structural mix is deposited at a deposit site and is allowed to self-harden to form a structural element.

### CROSS-REFERENCE TO RELATED APPLICATIONS

This application claims the benefit of U.S. Provisional Application No. 63/350,529 filed Jun. 9, 2022, and entitled CONSTRUCTION METHODS USING SYNTHETIC POLYMER BINDERS, which is incorporated herein by reference in its entirety.

### TECHNICAL FIELD

This invention relates generally to structural construction systems and methods. More particularly, the invention relates to a system and method for constructing a temporary or permanent structure at a building site from a “structural mix” formed using aggregate material available at or delivered to the building site along with a polymer binder (e.g., a liquid polymer binder), which may include a so-called “no-bake” binder. Additives to the structural mix, such as short or long fibers, including natural or synthetic fibers; powders; and chemical modifiers, may increase the strength and toughness of the resulting mix, or modify additional properties after a curing process is completed.

### BACKGROUND OF THE INVENTION

Road and civil construction improvements typically require earth-moving features, or poured or emplaced permanent concrete structures. There are many places that could be served by a semi-permanent bonded aggregate type of material where concrete work is not cost effective. For example, many locations, such as construction sites, farming and logging sites, gas and oil drilling sites, etc., are located in areas that have little or no infrastructure, including roads or buildings or other shelter. However, it is frequently necessary to transport goods, equipment, and people, to and through these locations. It is also often necessary to house and shelter goods, equipment and people in these locations as well. These locations are often located in extremely remote areas that may include soft ground, mud, swamp, wetlands, tundra, sand, or the like, where lack of infrastructure and roadways would make use of those locations difficult or impossible. For example, in these environments, typical heavy and other equipment (e.g. road building equipment, cranes, semi-trucks, etc.) may be unable to drive across a scraped or unprepared ground surface without experiencing sinking, jamming, etc. For this reason, heavy equipment used at the work site requires a suitable road bed that is stable to prevent the vehicle and the equipment, goods, people, etc. that it carries from becoming stuck.

In these cases, therefore, it is generally necessary to construct or improve road surfaces, fortifications, or other structures to allow for the transport, storage, or housing of goods, equipment, and people. Additionally, there may be cases where military forces may need to make use of fortifications or structures that are formed using locally-available construction materials (e.g., sand in the desert). It is frequently beneficial to increase the strength of these improvement, fortifications, or structures beyond the strength imparted using conventional construction methods.

Concrete can be used to form very strong structures. However, the production of concrete uses large amounts of water and, in many circumstances, it may be difficult or otherwise disadvantageous to import the necessary water needed to produce bonded aggregates from offsite to certain work sites (e.g., in the desert). Next, due to its strength, concrete is generally considered to be a somewhat permanent or long-term improvement. For example, chemically-bonded sand bags, walls, or embankments, may provide more protection and structural support compared to unbonded sand or aggregate. However, a problem in constructing more permanent road surfaces and structures using more traditional and resilient methods and materials is the level of planning, cost, and overall effort required to prepare the building site and to then transport materials to the building site. When concrete is used, it is typically mixed offsite in large quantities and then transported to the site, which is time consuming and expensive. For example, in military applications, pre-made concrete barriers, blocks, forms, or other similar mobile barriers are sometimes transported to those locations at great expense and with great difficulty. Also, for example, chemically-bonded sand bags, walls, or embankments, may provide more protection and structural support compared to unbonded sand or aggregate. Remoteness of some areas put them beyond the finite transportation time that exists when a batch of concrete is mixed offsite, placed in to a concrete truck at a concrete plant, and then transported to the building site. Often, it is also not economically feasible to create multiple concrete plants or to move concrete plants from one location to another in order to extend the delivery distance to cover remote work sites. Next, in many cases, the improvements, fortifications, and structures required are needed for a short period of time and are, therefore, temporary in nature. As such, the cost, time, and expense of constructing permanent structures and roads in such cases are not justified. Other conventional construction methods have also employed various polymers that have been in use since the 1970s. While these polymers have many positive material properties, they are significantly more expensive than cement, and their widespread use has been limited.

Even if the costs of constructing with concrete or other polymers are justified, there may be little or no time to plan and construct the necessary infrastructure before use of the area begins. In the past, attempts have been made to form temporary roads constructed by scraping the ground surface until it is sufficiently flat and level and then pouring asphalt over the scraped area directly onto the ground. This method of forming temporary roads is very fast and can be carried out with minimal planning. However, these temporary roads were fragile and often lacked sufficient strength for heavy use. For example, when a significant lateral force was applied to the road surface, such as a heavy truck, aggressively applying its brakes, the temporary road would tend to separate from the underlying ground surface and roll over onto itself beneath the vehicle's wheels.

What is needed, therefore, is a system and method for constructing a structure for at least temporary use at a building site more quickly, at a lower cost, and with greater strength than conventional systems and methods. Additionally, what is needed, is a system and method for constructing such a structure that minimizes the amount of equipment and raw materials that must be transported to the building site.

There is also a need for the ability to additively manufacture large bulk structures, employing a system that helps to automate this process would be valuable in reducing the time and manpower traditionally needed to achieve this.

### SUMMARY

The above and other problems are addressed by a method for constructing a structural element at a building site having an indigenous supply of aggregate material. In certain embodiments, the method includes the steps of: providing a mixer, providing a no-bake binder, sourcing aggregate material from the indigenous supply of aggregate material located at the building site, combining the binder with the aggregate material in the mixer to form a structural mix at the building site, and depositing the structural mix at a deposit site and allowing the structural mix to self-harden to form the structural element. In certain embodiments, the method further includes the step of combining a fiber additive to the aggregate material and no-bake binder to form the structural mix.

In certain cases, the no-bake binder is comprised of at least one of: phenolic urethane, polyol urethane, furan based, phenol-formaldehyde, or a geo-polymer. In certain cases, the deposit site is a mold and the structural element is placed at the building site. In certain cases, the deposit site is a reusable mold configured to receive the structural mix in a semi-flowable form and to release the structural element after the structural mix has self-hardened. In certain cases, the deposit site is a base formed on a ground surface located at the building site and the structural element is a section of road. In certain cases, the deposit site is a damaged section of a road surface and the structural element is a patch for the damaged section. In certain cases, the structural element formed by the structural mix is a road surface and, in at least certain cases, the deposit site is a bare ground surface (e.g., the structural mix is poured onto bare sand and the road is formed without any type of form or mold). In certain cases, the structural element formed by the structural mix is a temporary barrier. In certain cases, the aggregate material is comprised of at least one of sand or stone. In certain cases, the mixer is a continuous mixer. In certain cases, the aggregate used in the structural mix is comprised of approximately 60-100% sand, by weight. In certain cases, the structural element is formed from at least two structural mixes that each have a different composition.

The present disclosure also provide a structural building system that includes a structural element formed at building site from a structural mix comprised of an aggregate material sourced exclusively from the building site, a no-bake binder, and a strengthening additive. In certain cases, the strengthening additive is a fibrous additive that enhances the mechanical properties (e.g., tensile strength) of the structural element. In certain cases, the fibrous additive comprises poly-paraphenylene terephthalamide. In certain cases, the strengthening additive transmits a force acting on a first portion of the structural element to a second portion of the structural element, where the force acting on the first portion is not be transmitted to the second portion in the absence of the strengthening additive. Additionally, traditional concrete reinforcement techniques and reinforcement materials such as rebar or pre-stressed members are compatible with the presently-disclosed systems and methods. In certain cases, the system further includes a mold into which the structural mix is deposited and allowed to at least partially harden to form the structural element. In certain cases, the aggregate material includes at least one of sand and stone. In certain cases, the structural element is formed from at least two structural mixes that each have a different composition.

Finally, by using continuous mixers that are preferably programmable and controllable, complex and large structural elements that are made of resin, aggregates, and possibly containing reinforced members can be effectively additively manufactured (i.e., 3D printed). Filament style 3D printers can have deposition rates of 1.5 cubic centimeters per minute, binder jetting style printers can have deposition rates of 150 cubic centimeters per minute, and commercially-available concrete printers can have deposition rates of 120,000 cubic centimeters per minute. Typically, large, foundry-style continuous mixers rated at around 2,000 lb./min can have deposition rates of 0.75 cubic meters/minute, whereas very large mixers that are rated at around 4,000 lb./min can have deposition rates of 1.5 cubic meters per minute.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic.

Terms concerning attachments, coupling and the like, such as “connected” and “interconnected”, refer to a relationship wherein structures are secured or attached to one another either directly or indirectly through intervening structures, as well as both moveable and rigid attachments or relationships, unless specified herein or clearly indicated by context. The term “operatively connected” is such an attachment, coupling or connection that allows the pertinent structures to operate as intended by virtue of that relationship.

The term “no bake binder” means a chemical binder, such as a multi-part resin, that may be used as a binder in connection with the formation of concrete and that does not require external heat in order to set or cure. The term “structural mix” means a mix that is used in forming a self-hardening structural element that does not require external heat to set or cure, where the mix is formed from an aggregate that has been sourced from a building site a no-bake binder.

The use of any and all examples or exemplary language (e.g., “such as” and “preferably”) herein is intended merely to better illuminate the invention and the preferred embodiment thereof, and not to place a limitation on the scope of the invention. Nothing in the specification should be construed as indicating any element as essential to the practice of the invention unless so stated with specificity.

### BRIEF DESCRIPTION OF THE DRAWINGS

The presently preferred embodiments of the invention are illustrated in the accompanying drawings, in which like reference numerals represent like parts throughout, and in which:

FIG. 1 depicts a building site having an indigenous supply of aggregate material at three different stages of a building process for constructing a structure at the building site using a structural mix according to an embodiment of the present invention;

FIG. 2 is an exploded view depicting an internal structure of a structural element, formed using a structural mix according embodiments of the present invention, having varied resin concentrations and/or additives throughout a continuously cast aggregate structure;

FIGS. 3-5 are detail views of portions of the building site illustrated in FIG. 1 indicated by “FIG. 3,” “FIG. 4,” and “FIG. 5,” respectively;

FIG. 6 is a sectional view of a mold that is in the process of being filled with a structural mix formed from an aggregate and a no-bake binder according to an embodiment of the present invention; and

FIGS. 7 and 8 illustrate completed structural elements formed using the mold depicted in FIG. 6; and

FIG. 9 depicts a mobile carrier comprising a mixer mounted to a vehicle according to an embodiment of the present invention.

### DETAILED DESCRIPTION OF THE INVENTION

This description of the preferred embodiments of the invention is intended to be read in connection with the accompanying drawings, which are to be considered part of the entire written description of this invention. The drawings are not necessarily to scale, and certain features of the invention may be shown exaggerated in scale or in somewhat schematic form in the interest of clarity and conciseness.

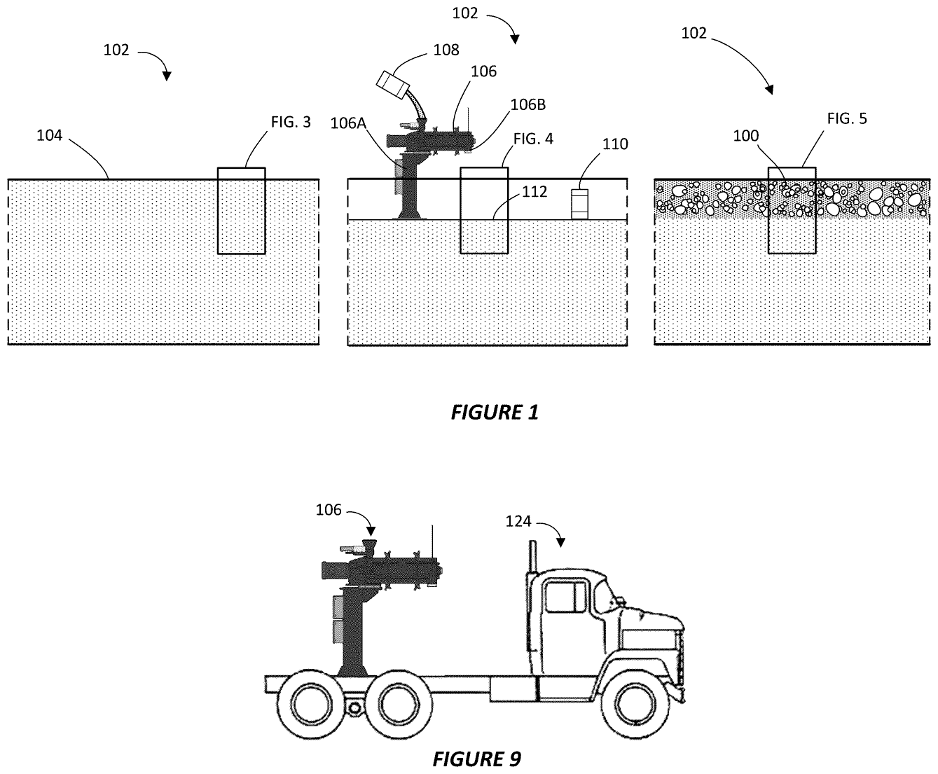

With reference to FIG. 1, the present disclosure relates to a method and system for building a structural element 100 at a building site 102 using a structural mix that is formed using aggregate sourced from a supply of aggregate material 104. Preferably, the aggregate material is naturally occurring or otherwise found at the building site 102 so that transportation of aggregate material to the building site is not required. Instead, the aggregate material 104 used in forming the structural element 100 is partially sourced or, more preferably, exclusively sourced from the building site 102. Less preferably, in some cases, aggregate used in the structural mix is sourced from around the building site 102 or is sourced from somewhere other than the building site. Suitable aggregates may include commercial grade, all-purpose, playground sand, gravel, pebbles, and other types or grades aggregates.

In some cases, “precast” or “preformed” structures, such as slabs, road dividers, etc., may be formed off site and transported to the worksite. In certain cases, it may still be more economical to produce precast or preformed structures from an aggregate bonded by typical foundry resins than traditional concrete. In this particular case, the building site 102 is an arid climate, such as a desert, and the aggregate material 104 material is comprised primarily of sand and/or stone that is preferably sourced from that environment. In preferred embodiments, the aggregate is comprised of approximately 60-100% sand, by weight. However, at other building sites 102, other types or compositions of aggregate that may be sourced from those building sites may be used.

In addition to those materials that are already located at the building site 102, a certain amount of equipment and raw materials may also be transported to the building site 102. Preferably, the amount of equipment and raw materials that are transported to the building site 102 are minimal in order to reduce the cost and time required to construct the structural element 100. Equipment and materials that may be transported to the building site 102 may include a mixer 106, a binder 108, and one or more additives 110 (e.g., pebbles, gravel, fibers, etc.). The precise type of additives used may be modified depending on the application and the needs of the application. For example, natural or synthetic fibers may be used in certain cases. Also, a single continuous or a plurality of separate fibers may be provided in each structural element. In certain embodiments, the mixer 106 is a continuous mixer of the type often used in the foundry industry. For example, in the illustrated case, the mixer 106 is a continuous sand mixer having a swiveling base and also having a deposition end 106A from which the structural mix flows from the mixer.

Preferably, mixer 106 is capable of mixing at rates of over 1000 lbs. of materials per minute or more. Mixer 106 may be stationary or mounted on a mobile carrier 124 (FIG. 9), such as vehicle or mobile stand. Depending on the type of features or structure being created, a batch mixer may be employed instead of a continuous mixer. Preferably, the mixer 106 is programmable and controlled with an electronic program and control system. By using pre-specified instructions and recipes, the electronic program and control system can form large and complex structures (e.g., a road) with either homogeneous or non-homogeneous properties. Additionally, in certain embodiments, the mixer 106 is capable of additively manufacturing (i.e., 3D printing) structures as well. In certain embodiments, mixer 106 is provided with movable portions (e.g., arms) that rotate or even articulate, in order to provide a range of motion and a range of coverage, preferably including lateral movement (e.g., side-to-side, front-to-back, or both) and vertical movement (e.g., up or down), and thereby allowing a large area to be potentially covered from a fixed position. For example, suitable mixers 106 include the Spartan II and the Omega 200 series mixers by Omega Sinto Foundry Machinery Ltd.

In use, this type of mixer usually deposits sand mixes in a desired arrangement in order to form molds used in the foundry process. However, according to the presently-described systems and methods, by employing a mixer with the features described above, structures such as roads, bridges, structural foundations, or other similar large bulk structures can be directly built by mixer 106. Preferably, these structures are built using an automated (i.e., programmed) additive manufacturing process.

Next, in preferred embodiments, the binder 108 comprises a multi-part liquid binder. For example, so called “no-bake” binders or resins comprise several families of chemical bonding agents. No-bake resins are engineered to be a low cost, high performance material that is suitable for use in mass production environments. These characteristics of no-bake binders make them well suited for use in the presently-described process. Generally, these types of binders utilize a catalyst reaction to produce a hardened bond and that cures under ambient conditions without the addition of heat, gas, water or vapor. For example, suitable no-bake binders 108 may be comprised of at least one of a multi-part polymeric binder, examples including phenolic binder (e.g. phenolic urethane), furan binders including furan-phenol hybrids, resole (phenol-formaldehyde), urethanes (e.g., polyol urethane), and so called geo-polymers such as sodium silicate, alkyd, alkaline phenolic, and poly-urethane isocyanates.

One of the key features of these and other similar binders is that the curing time, or time needed to reach approximate maximum strength of the bonded aggregate is very fast relative to traditional concrete. For example, these chemically-bonded aggregates may reach their working strength on the time scale of minutes to hours, whereas conventional concretes may take days or weeks to fully cure. This rapid strength development is an important feature for producing mixed aggregates quickly that are needed only on a temporary basis. Preferably, the temporary structures made of this mixture can be used within 24 hours and, more preferably, on the same day that they are formed. This is a distinctly different attribute that would separate these bonded aggregates from traditional concrete, and would be of benefit when constructing features shortly after natural disasters, in remote locations, time sensitive military applications and other locations where time plays an important factor. Suitable binders for the presently-disclosed systems and methods include a combination of one or more of the following and/or other similar “no-bake” resin components: Bioset T8000, part 1; Techniset 6435, part 2; and Techniset 6700 catalyst.

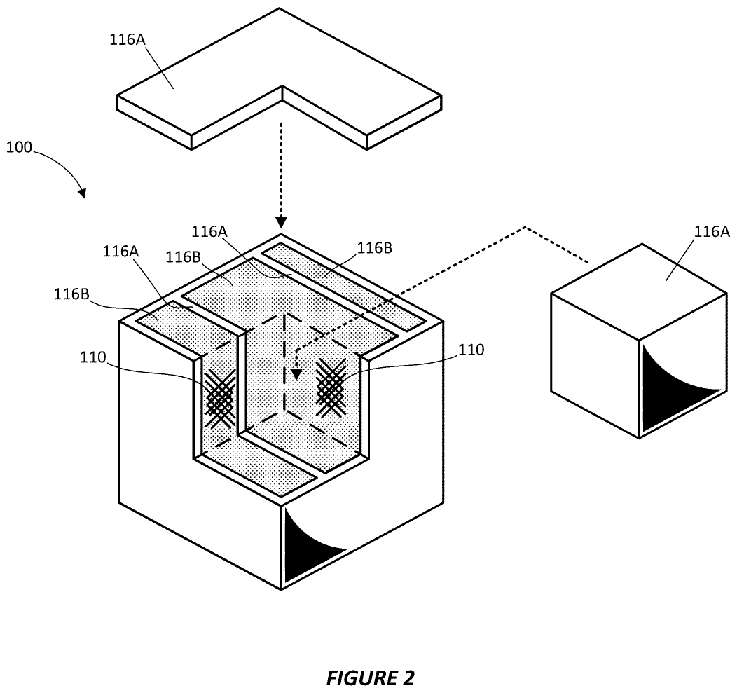

With reference to FIG. 2, an exploded view of a structural element 100 according to an embodiment of the present invention is shown. As shown, in certain embodiments, the relative quantities of binder, additives, and binder may be adjusted throughout the structural element 100 in order to produce localized inclusions having desired material properties that differ from surrounding areas, while still creating a single structure.

Creating a single structure with varied properties is something not typically seen with traditional concrete. For example, the percentage of one component of the structural mix (e.g., the resin) relative to other components of the structural mix (e.g., the aggregate) can be changed throughout the structural element 100 in order to provide desired properties in certain areas of the structural element. For example, as shown in FIG. 2, a first structural mix (used in areas identified by Ref. No. 116A) having a first percentage of one component of the structural mix (e.g., resin) relative to other components of the structural mix may be used in certain portions of the structural element 100. At the same time, a second structural mix (used in areas identified by Ref. No. 116B) having a second and different percentage of the component (e.g., resin) relative to other components of the structural mix may be used in other portions of the structural element. Resin adds strength to the structural mix but it also increases cost. Therefore, it would be advantageous and a cost savings to use a stronger structural mix in areas of the structural element 100 that experience higher or more demanding loads or impacts relative to other portions of the structural element.

For example, in the illustrated embodiment, the edges and outer surfaces of the structural element 100 employ a stronger but more expensive first structural mix 116A. Additionally, inclusions 118 (e.g., strengthening ribs) may be formed within the interior of the structural element 100 and employ the first mix 116A. On the other hand, a less expensive second mix 116B may be used in other portions of the structural element 100, such as the interior, where the lower loads or impacts are experienced. By doing this, the effective strength of the structural element would be not significantly compromised, but it would be much more economical as the binders would have a higher material cost than the base aggregate. Of course, in other embodiments, it may be advantageous to modify the presence and/or relative percentage of other components of the structural mix throughout the structural element 100 in order to provide desired properties in specific locations. For example, chemical additives or chemically compatible but different binders that are more UV resistant or that are more heat/cold resistant may be used near the exterior surfaces of the structural element 100 that are exposed to the elements. Accordingly, in certain embodiments, the mixer 106 is preferably configured to modify the structural mix from a first composition to a second and different composition. Even more preferably, the mixer 106 is a programmable continuous mixer that is able to modify the composition of the structural mix automatically according to a pre-defined program and while the mixer is in a continuous mixing operation (i.e., “on the fly”).

In certain embodiments, in order to modify the brittleness or failure mode of the resin-bonded aggregate structural element 100, fibrous or other additives 110 may also be employed as an additional inclusion within the structural mix. In the illustrated embodiment, a fibrous mesh 110 is shown as an inclusion within structural element 100. Preferably, the fibrous additive 110 disperses forces throughout the aggregate material and allows the transmission of forces beyond the individual aggregate particles (e.g., sand grains) that are immediately adjacent the particle where a force is being applied. As a result, the force from a point load or impact, for example, would be more widely dispersed throughout the structural element 100 and would reduce the possibility of a resulting failure of the structural element. More specifically, in certain embodiments, fiber-based “force transmission bridges” help to distribute forces from the local unit cell of adjacent aggregate, further out in to the surrounding material, beyond the aggregate that is in immediate contact with each other. Such bridges help to impart toughness to a traditionally brittle material, and may prevent spontaneous failure of larger structures. These additives 110 may include poly-paraphenylene terephthalamide (i.e., Kevlar) fibers, fiberglass fibers, carbon fibers, or other types of fibers. It is noted that other fibers, natural or manmade, may be more advantageous based on the desired properties of the cured aggregate mix. Additionally, other reinforcements, such as rebar or pre-stressed members (not shown), which are commonly used in traditional concrete construction are compatible with the systems and methods described herein.

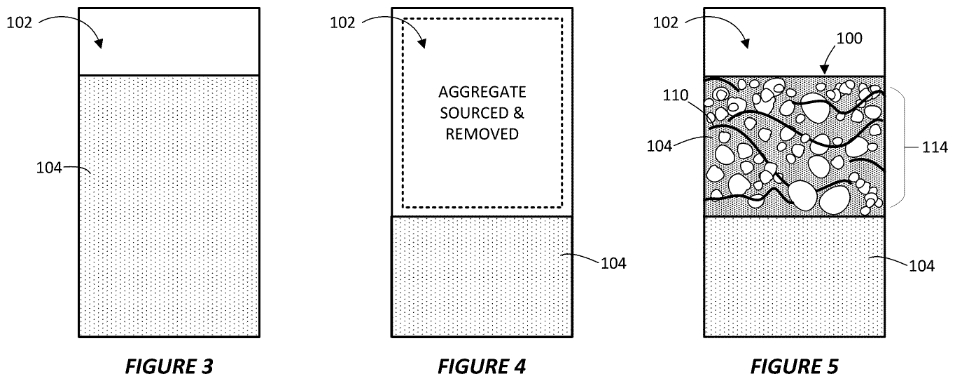

With reference again to FIG. 1, when viewed from left to right, a method for constructing a structural element 100 at a building site 102 having an indigenous supply of locally-sourced and, preferably, naturally-occurring aggregate material 104 that is native to the building site according to a first embodiment of the present invention is illustrated. Additionally, detailed views of portions of the building site 102 of FIG. 1 are shown in FIGS. 3-5.

Preferably, after the minimum necessary equipment and materials have been provided to the building site 102, aggregate material 104 is sourced locally. This may include the combination or mixture of multiple types of locally-sourced aggregate material. Although not preferred, it is also anticipated that, in at least certain implementations, aggregate material that is not locally sourced may form part of the structural mix. FIG. 3 illustrates the building site 102, which includes local aggregate material 104, before any work has been performed. Then, in FIG. 4, at least a portion of the aggregate material 104 is preferably removed from the site 102 or the surrounding local areas and is then added to the mixer 106 (FIG. 1) along with a binder 108 and, optionally, one or more additives 110, including potentially fibrous additives. The components are then mixed together in the mixer to form structural mix 114. In certain embodiments, the structural mix 114 is comprised of approximately 1-10% resin by weight. However, as indicated above, other mixes having higher or lower relative percentages of mix components, including differing percentages of resin, are contemplated. Preferably mixer 106 is configured to adjust the composition of the structural mix on demand or based on a program or design. In other cases, multiple batches of structural mix may be formed according to different recipes and then deposited together to form a single, combined structure.

As such, as previously described, structural mix 114 may modified to form multiple mixes that have differing properties (e.g., first structural mix 116A and second structural mix 116B, shown in FIG. 2). After the structural mix 114 has been formed, it is deposited at a deposit site 112 located at the building site 102. The structural mix 114 is preferably at least a semi-flowable mix that self-hardens to form the structural element 100. In the depicted embodiment, the deposit site 112 is a base formed on a ground surface and the structural element 100 is a section of road that is poured onto the deposit site. In some cases, the structural element 100 is only a portion of a road, such as a fill for a damaged portion of a road (e.g., a pothole). In other cases, the structural element 100 is the entire road surface.

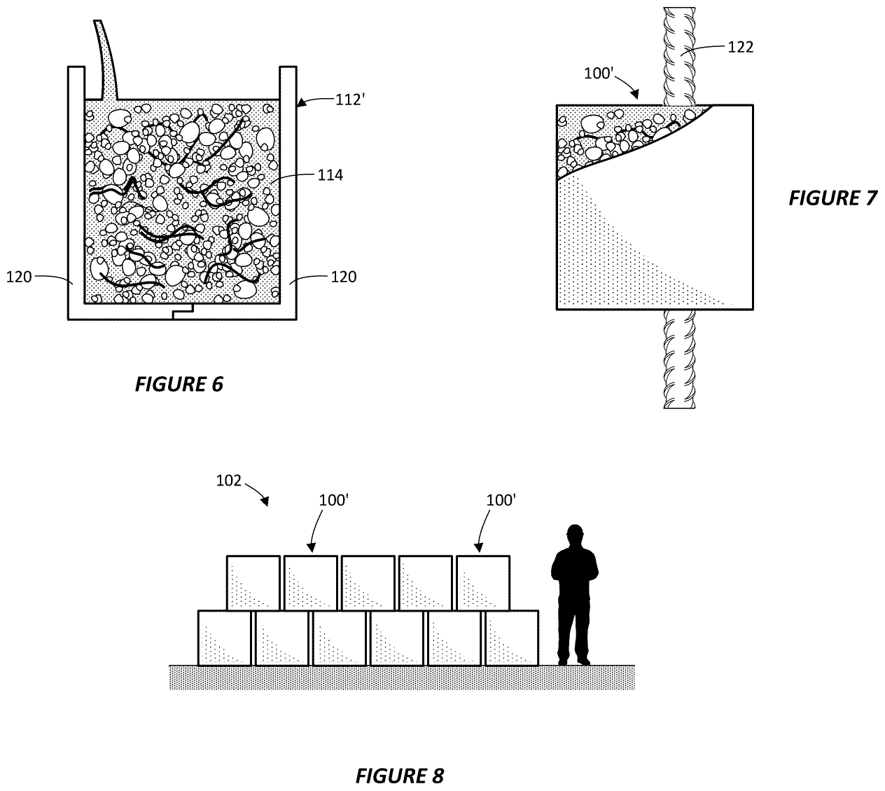

Finally, with reference to FIGS. 5-8, in other embodiments, deposit site 112′ is a mold that may be used to form structural element 100′ that may be placed at building site 102, and which may include blocks, walls, floors, temporary barriers (e.g., Jersey barriers), bricks, etc. Preferably, mold 112′ is a reusable mold that is configured to receive the structural mix 114 in its flowable form and to then release the structural element 100′ after the mixed aggregate has at least partially self-hardened. Therefore, in certain embodiments, mold 112′ is formed using two or more separable portions 120. This would enable the mold 112′ to be used repeatedly to form multiple identical copies of structural element 100′. In order to minimize the amount of materials, equipment, and time needed to form the structural element 100′, the structural element is preferably strong enough to be used without a mold 112′ or enclosure. In other words, the structural element 100′ can be used after the mold 112′ has been removed. Additionally, as noted above, traditional concrete reinforcement techniques and reinforcement materials (collectively and generally referred to by Ref. No. 122, shown in FIG. 7), such as rebar, angle iron, I-beams or pre-stressed members are compatible with the presently-disclosed systems and methods. As shown, such reinforcement materials 122 may be formed as part of the structural element 100′ during the casting process.

### Example/Test Data

A series of destructive tests using a hydraulic test stand were performed in order to measure the compressive strength, namely the ultimate compressive strength, of each of several samples. As a non-limiting example of the test methods used, in one test, a sample in the form of a cylinder measuring 4 inches in diameter by 8 inches in height was created for each of several different structural mixes. In particular, in forming the test samples, ingredients were measured using mixing cups, which were wetted, rinsed, tared, and reused. Then, disposable molds were sprayed with a release agent (e.g., Crisco® non-stick spray). Next, aggregate (e.g., sand) and additives were mixed together in a mixing bucket using a power drill. An appropriate amount of Techniset 6435, part 2 (i.e., “Part 2”), was then mixed with the aggregate using a power drill. A corresponding appropriate amount of Bioset T8000 and Techniset 7000, part 1 (i.e., “Part 1” and catalyst) was then mixed with the aggregate and Part 2 using a power drill. These Parts 1 and 2 were mixed separately from each other in order to avoid poor mixing. The mixture was then added to the mold by hand and was packed well using the “good core pack” method. The disposable molds were then cut open and the samples were removed and placed into an airtight container for storage until testing.

In each of the test cases that follow, the percentage of resin is measured based on the weight of the sand. Therefore, if 15 pounds of resin were added to 100 pounds of sand, that mixture would be comprised of 15% resin. All other components are measured based on the total overall weight of the final mix.

Test 1

A high-strength mix (Cylinder #50) sample was formed using a method similar to that described above and using 15% resin, 3% catalyst, and Quikrete® all purpose sand. The sample was then allowed to cure for 5 days. In testing, this sample exhibited a breaking force of 77,040 pounds and a compressive strength of 6,130 pounds per square inch.

Test 2

In another test intended to test the impact of different types of aggregate, six samples were prepared and tested. The mixture, aggregate, aging, and test result for each of these samples are shown below:

| | | COMPRESSIVE |
|---|---|---|
| SAMPLE | MIXTURE PARAMETERS | STRENGTH (psi) |
| Cylinder #34 | Quikrete ® commercial grade | 2,830 |
| | medium sand and 8% resin. 6 days' | |
| | cure time | |
| Cylinder #43 | Quikrete ® commercial grade | 2,690 |
| | medium sand, 25% gravel, 8% resin | |
| | based on weight of sand, 6% resin | |
| | based on total weight. 8 days' cure | |
| | time. | |
| Cylinder #30 | Quikrete ® commercial grade | 2,230 |
| | medium sand and 6% resin. 2 days' | |
| | cure time | |
| Cylinder #13B | Quikrete ® commercial grade | 810 |
| | medium sand and 2% resin. 4 days' | |
| | cure time | |
| Cylinder #20 | Quikrete ® commercial grade | 880 |
| | medium sand, 50% gravel, 4% resin | |
| | based on weight of sand, 2% resin | |
| | based on total weight. 2 days' cure | |
| | time. | |
| Cylinder #21 | Quikrete ® commercial grade | 490 |
| | medium sand, 50% round pebbles, | |
| | 4% resin based on weight of sand, | |
| | 2% resin based on total weight. 2 | |
| | days' cure time. | |

Test 3

In another test intended to test the impact of compaction methods, four samples were prepared and tested. In each of these samples, Quikrete® commercial grade medium sand along with 2% resin was used. Additionally, each sample was allowed to cure for 2 days. The compaction method and test result for each of these samples are shown below:

| | | COMPRESSIVE |
|---|---|---|
| SAMPLE | MIXTURE PARAMETERS | STRENGTH (psi) |
| Cylinder #12 | Good core pack method. | 2,830 |
| Cylinder #13A | Modified C31 method. | 2,690 |
| Cylinder #30 | Good core pack method. | 2,230 |
| Cylinder #32 | Gravity drop method. | 810 |

Test 4

In yet another test intended to test the impact of fiber, six samples were prepared and tested. The mixture and test result for each of these samples are shown below:

| | | COMPRESSIVE |
|---|---|---|
| SAMPLE | MIXTURE PARAMETERS | STRENGTH (psi) |
| Cylinder #13B | Quikrete ® commercial grade | 780 |
| | medium sand and 2% resin. 4 days' | |
| | cure time | |
| Cylinder #16 | Quikrete ® commercial grade | 470 |
| | medium sand, 2% resin, and 1% 6 | |
| | mm glass fibers. 4 days' cure time | |
| Cylinder #19 | Quikrete ® commercial grade | 1,470 |
| | medium sand and 4% resin. 2 days' | |
| | cure time | |
| Cylinder #22 | Quikrete ® commercial grade | 1,060 |
| | medium sand, 4% resin, 0.5% | |
| | handcut nylon fibers. 2 days' cure | |
| | time | |
| Cylinder #34 | Quikrete ® commercial grade | 2,830 |
| | medium sand and 8% resin. 6 days' | |
| | cure time | |
| Cylinder #44 | Quikrete ® commercial grade | 2,840 |
| | medium sand, 8% resin, and 0.17% | |
| | 6 mm glass fibers. 8 days' cure | |
| | time | |

Test 5

In yet another test intended to test the impact of aging the finished product, three samples were prepared and tested. In each of these samples, Quikrete® commercial grade medium sand along with 8% resin was used. The curing time and test result for each of these samples are shown below:

| | | COMPRESSIVE |
|---|---|---|
| SAMPLE | MIXTURE PARAMETERS | STRENGTH (psi) |
| Cylinder #38 | 1 days' cure time | 2,680 |
| Cylinder #37 | 59 days' cure time in airtight chamber | 3,280 |
| Cylinder #39 | 59 days' cure time in humidity | 2,120 |
| | chamber | |

Although this description contains many specifics, these should not be construed as limiting the scope of the invention but as merely providing illustrations of some of the presently preferred embodiments thereof, as well as the best mode contemplated by the inventor of carrying out the invention. The invention, as described and claimed herein, is susceptible to various modifications and adaptations as would be appreciated by those having ordinary skill in the art to which the invention relates.

Although this description contains many specifics, these should not be construed as limiting the scope of the invention but as merely providing illustrations of some of the presently preferred embodiments thereof, as well as the best mode contemplated by the inventor of carrying out the invention. The invention, as described and claimed herein, is susceptible to various modifications and adaptations as would be appreciated by those having ordinary skill in the art to which the invention relates.

What is claimed is:

1. A method for constructing a structural element at a building site having an indigenous supply of aggregate material, the method comprising the steps of:
A. providing a mixer;
B. providing a no-bake binder;
C. sourcing aggregate material from the supply of indigenous aggregate material located at the building site;
D. combining the binder with the aggregate material in the mixer to form a structural mix at the building site; and
E. depositing the structural mix at a deposit site and allowing the structural mix to self-harden to form the structural element.

2. The method of claim 1 wherein the no-bake binder is comprised of at least one of: phenolic urethane, polyol urethane, furan, phenol-formaldehyde, or a geo-polymer.

3. The method of claim 1 further comprising the step of combining a fiber additive to the aggregate material and no-bake binder to form the structural mix.

4. The method of claim 1 wherein the all aggregate material used in forming the structural element is sourced exclusively from the building site.

5. The method of claim 1 wherein the deposit site is a reusable mold configured to receive the structural mix in a semi-flowable form and to release the structural element after the structural mix has self-hardened.

6. The method of claim 1 wherein the deposit site is a bare ground surface located at the building site and the structural element is a section of road.

7. The method of claim 1 wherein the deposit site is a damaged section of a road surface and the structural element is a patch for the damaged section.

8. The method of claim 1 wherein the structural element formed by the structural mix is a mobile structure.

9. The method of claim 1 wherein the aggregate material is comprised of at least one of sand or stone.

10. The method of claim 1 wherein the mixer is a continuous mixer having a deposition end for depositing the structural mix at the deposit site, wherein the deposition end is disposed on a movable arm having at least one articulating portion.

11. The method of claim 10 wherein the continuous mixer is a programmable mixer and is a 3D printer, the method further comprising the step of using the mixer in an additive manufacturing process to produce the structural element.

12. The method of claim 10 wherein the mixer is a programmable continuous mixer, the method further comprising the step of modifying a composition of the structural mix from a first composition to a second and different composition according to a pre-defined program and while the mixer is in continuous mixing operation.

13. The method of claim 1 wherein the aggregate of the structural mix is comprised of approximately 60-100% sand, by weight.

14. The method of claim 1 wherein the deposit site is located at the building site and the structural element is a structural foundation or a large structure.

15. The method of claim 1 wherein the mixer is mounted to a mobile carrier, the method further comprising the step of moving the mixer using the mobile carrier.

16. The method of claim 15 wherein the mixer and mobile carrier are moved while the mixer is either forming or depositing the structural mix.

17. The method of claim 1 wherein the structural mix self-hardens to form the structural element and is suitable for use within 24 hours.

18. A structural building system comprising: a structural element formed at a building site from a structural mix comprised of an indigenous aggregate material that is sourced from the building site, a no-bake binder, and a strengthening additive.

19. The building system of claim 15 wherein the strengthening additive is a plurality of separate fibers formed into the structural element and that enhance the tensile strength of the structural element.

20. The building system of claim 15 wherein the aggregate material comprises at least one of sand and stone.
